(19) United States
(12) Patent Application Publication
(10) Pub. No.: US 2018/0293554 A1
(43) Pub. Date: Oct. 11, 2018

(54) ELECTRONIC FUNDS AND RECEIPT TRANSFER SYSTEM

(71) Applicant: Mark JOHNSON, Western Australia (AU)

(72) Inventor: Mark JOHNSON, Western Australia (AU)

(21) Appl. No.: 15/964,795

(22) Filed: Apr. 27, 2018

Related U.S. Application Data
(63) Continuation-in-part of application No. 13/387,846, filed on Apr. 2, 2012, now abandoned.

(30) Foreign Application Priority Data
Aug. 5, 2009 (AU) 2009903652
Dec. 24, 2009 (AU) 2009906303

(51) Int. Cl. G06Q 20/04; G06Q 20/10; G06Q 20/08

(52) U.S. Cl. CPC G06Q 20/0453; G06Q 2220/00; G06Q 20/0855; G06Q 20/102

(57) ABSTRACT

A system and method for providing an electronic funds and receipt transfer system capable of making available to the customer or other authorised third party, receipt data relating to an EFTPOS transaction in an electronic format (26). In accordance with one preferred embodiment, the receipt data generated by the merchant at the time of sale is attached to the EFTPOS transaction data and sent using the same channels as known EFTPOS systems (16). Alternatively the receipt data may be transferred to a third party location for later retrieval. To access the receipt data the system allows the customer to access their financial institutions internet banking webpage (22) and print, save or email a copy of the receipt (26) as generated by the merchant at the time of sale.

### FIELD OF THE PRESENT INVENTION

The present invention relates to an electronic funds and receipt transfer system.

### BACKGROUND OF THE INVENTION

Currently Electronic Fund Transfer Point Of Sale (EFTPOS) systems are used extensively in the retail environment.

Current EFTPOS systems generate a large amount of paper receipts for the customers who use their service. In the existing EFTPOS systems either a receipt combining the merchant's receipt and the EFTPOS transaction receipt or two receipts, one being the merchant's receipt, the other the EFTPOS transaction receipt, are created. Many of receipts produced are either lost or damaged within a few days of being created. It is known that many merchants also print EFTPOS receipts on thermally active paper which will are known to fade over time.

In the case of existing EFTPOS systems these receipts cannot be regenerated. This gives rise to a problem when a customer needs to verify at a later date that the purchase was made and the nature of the purchase.

Other systems and methods have been described to attempt to solve this problem such as described in U.S. Patent Application Publication US2004/0064373A1. Systems like the one described in the above U.S patent application have aimed at capturing and storing the receipt of the electronic transaction, not a copy of the Merchant's receipt or an itemised account of what was purchased.

The present invention attempts to overcome at least in part the aforementioned disadvantages of previous systems and methods.

### SUMMARY OF THE PRESENT INVENTION

In accordance with one aspect of the present invention there is provided a system for the transmission and storage of electronic receipt data relating to electronic funds transfers, characterised in that merchant receipt data and EFTPOS transaction data are transmitted electronically to at least one remote location, such that a re-creation of the original receipt, as produced by the merchant at the time of the transaction, is made available to the customer in an electronic format.

Optionally, there is provided a system wherein data from the merchant's receipt data and the EFTPOS transaction data is encrypted and/or compressed prior to transmission. Further, data may be transmitted to a third party location where it may be stored.

Preferably, the third party location is a server farm. In this case the data is stored at the server farm from where it may be transmitted by the customer's financial institution or another authorised party.

In accordance with a further aspect of this present invention there is provided a method for the transmission and storage of electronic receipt data relating to an electronic funds transfer, the method characterised by:
Attaching the merchant's receipt data to the EFTPOS transaction data;
Transmitting electronically merchant receipt data and EFTPOS transaction data to at least one remote location;
Linking the receipt data and EFTPOS transaction data to the customer's account; and
Making an electronic copy of the merchant's receipt available to the customer.

### BRIEF DESCRIPTION OF THE DRAWINGS

The present invention will now be described, by way of example, with reference to the accompanying drawings, in which:

FIG. 1 is a reproduction of an EFTPOS transaction receipt;

FIG. 2 is a reproduction of a Merchant's receipt for an EFTPOS transaction; and

FIG. 3 is a process chart describing one embodiment of the method of the present invention.

### DESCRIPTION OF THE INVENTION

Financial institutions referred to herein may include, but are not limited to banks, building societies, credit unions, authorised deposit taking institutions (ADI's), government departments, retail stores offering gift card services and credit card providers.

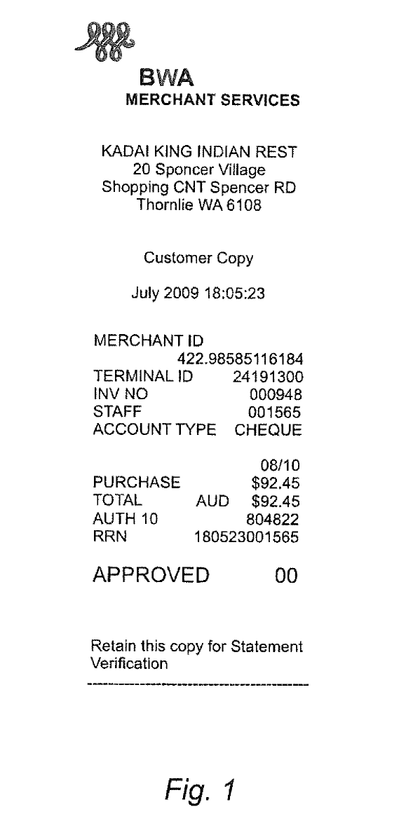

With reference to FIG. 1, there is shown an EFTPOS transaction receipt. Receipts such as this are generated every time an EFTPOS transaction is conducted. The information contained on the EFTPOS transaction receipt is limited. Known EFTPOS transaction receipts show the amount of money that the customer has transferred to the Merchant's account, as well as other details regarding the Card used(such as the card number and account type), the Merchant I.D. number, the terminal number and the transaction number. Such a receipt cannot be used to prove that a specific item was purchased from a Merchant as it only shows that a purchase was made. Further, the EFTPOS transaction receipt alone is not appropriate for claiming a tax refund for the reasons discussed above.

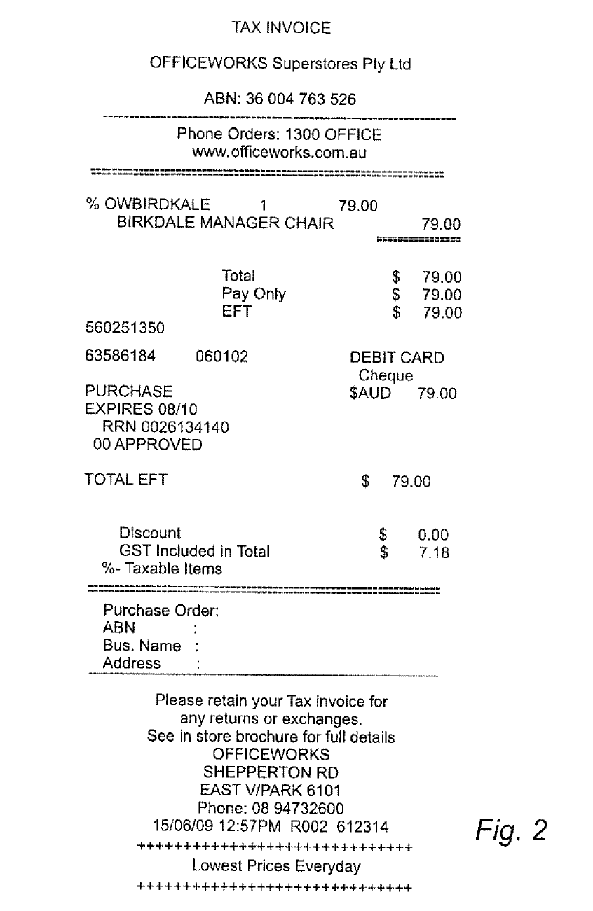

With reference to FIG. 2, there is shown a Merchant's receipt that shows the EFTPOS transaction inclusively on the receipt. It can be seen that the items purchased are clearly shown as well as the individual item price. This receipt would be sufficient for claiming a tax refund or to claim an expenses deduction. Additionally the customer can clearly ascertain when the purchase was conducted and what exact items were purchased.

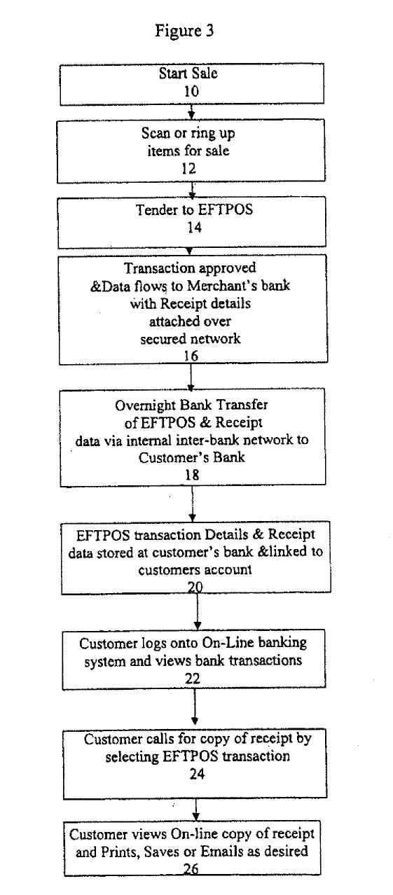

Referring to FIG. 3, there is shown a system and a method for transferring receipt data to a Customer's financial institution to allow the customer to access a copy of the Merchant's receipt data at a later date. This receipt data may be attached to the EFTPOS data that is normally transferred to the Merchant's financial institution upon the completion of an EFTPOS transaction. Alternatively, the receipt information may be transferred to a third-party location such as a server farm, for retrieval by the Customer's financial institution or other authorised third party as required.

In operation, using the system of the present invention, the transaction begins with the customer selecting what goods and/or services they wish to purchase from a Merchant at 10. The merchant then enters the sale information into their POS system at 12 using an appropriate means such as barcode scanning or PLU's. Once the customer elects to pay by electronic funds transfer at 14, EFTPOS transaction data is generated and the computer system of the Merchant's POS system would normally transmit this data to the Merchant's financial institution upon approval of the transaction.

In accordance with one preferred embodiment of the present invention, once the EFTPOS transaction is approved and logged by the Merchant's POS system, additional data is attached to the data used for the EFTPOS transactions. The merchant's POS system passes electronic data (containing EFTPOS transaction data and merchant receipt data) to the system of the present invention. The system of the present invention then transmits over a secure connection (such as a digital subscriber line, a Virtual Private Network (VPN) or the internet) this data to the Merchant's financial institution where the EFTPOS transaction data would normally have been destined at 16. The additional data attached to the EFTPOS transaction data comprises the merchant's receipt data such as individual items purchased and any data necessary to recreate the receipt at a later date.

To reduce the size of the data that is attached to the EFTPOS transaction data items such as the Merchant's logo or trade mark may not be included in the transferred data. Commonly reproduced data such as the merchant's logo, trade mark, address or header and footer data could be stored with or linked to the merchant's EFTPOS Merchant I.D. number for ease of identification.

Once the combined merchant receipt and EFTPOS transaction data is transmitted by the system of the present invention and is received by the Merchant's financial institution at 16, it is normal practice for merchant's financial institution to store this data for transfer to the customer's bank at a later time.

At a predetermined time, at which the Merchant's financial institution would normally transfer the data of the EFTPOS transaction to the Customer's financial institution at 18, the combined receipt and EFTPOS transaction data is automatically transmitted to the customer's financial institution.

A known computer system of the Customer's financial institution would normally process the EFTPOS transaction data and make appropriate links and entries in the customer's account. In this preferred embodiment of the present invention the computer system of the customer's financial institution also processes the merchant receipt data that is also passed to the Customer's financial institution at 20. As the Customer's financial institution processes the combined merchant receipt and EFTPOS transaction data, the computer system of the customer's financial institution will make appropriate links and entries in the customer's account.

Optionally, the computer system of the customer's financial institution may not process the receipt data and instead store it until such time as it is requested by the customer as described below. The length of time that the merchant receipt data is stored by the computer system of the customer's financial institution is dependent upon the policies or legal requirements of the financial institution.

The linking of the merchant receipt data and EFTPOS transaction data to the customer's account will then enable customers to log on to their financial institution's internet banking webpage at 22 and view the receipts linked to each EFTPOS transaction at 24.

The Merchant's logo or trade mark and any other information that is not transmitted as it is obviously repeated on every receipt may be generated from a copy stored at the Customer's financial institution or the third party location. Using techniques known in the art the receipt, the receipt data and the EFTPOS transaction data will have such additional information added to it, to enable the customer to view the receipt in their internet browser at 26.

It will then be possible for the customer to duplicate the information on the receipt by appropriate means be that printing a copy, saving a copy of the receipt to an electronic formatting device or even via email as an attachment, with such functionality coming from the Customer's internet browser.

In accordance with another preferred embodiment of the present invention, the merchant receipt data and the EFTPOS transaction data maybe encrypted and/or compressed at any stage of the above described process as required to ensure security or to reduce the size of the data being transmitted.

In another exemplary embodiment of the invention the Merchant's POS system passes electronic data to the system of the present invention, the system of the present invention does not attach the merchant receipt data to the EFTPOS transaction data transferred to the Customer's financial institution. In this embodiment the merchant receipt data and a copy of at least some of the EFTPOS transaction data are transferred to a third party location such as a server farm. The transfer of receipt data to the third party location is conducted via a secure connection. The EFTPOS transaction data transferred to the third party location is that which is necessary to match the transactions with the records of the Customer's financial institution. In accordance with this embodiment, the data sent from the third party location is sent automatically to the Customer's financial institution at a predetermined time. Upon receipt of the data, the EFTPOS data sent with the receipt data is used to match the merchant's receipt data with the EFTPOS transaction data that has been received by the Customer's financial institution in the known manner, at which time the computer system of the financial institution will make appropriate links and/or entries in the customer's account.

Optionally, the data contained in the merchant receipt to be sent by the system of the present invention is encrypted and/or compressed using a conventional compression algorithm. This reduces the size of the data transfer, when the receipt data and at least some of the EFTPOS data are sent to the third party location. This will reduce the amount of storage required to store the merchant receipt data and the EFTPOS transaction data at the third party location. In accordance with this embodiment the merchant receipt data may be stored in this encrypted and/or compressed form until retrieved as described herein.

In another preferred embodiment of the present invention, the merchant receipt data is not attached to the EFTPOS transaction data of the customer's financial institution but is sent along with at least some of the EFTPOS data to a third party location via a secure connection as outlined above. However, in this embodiment the merchant receipt data is held at the third party location until such time that the Customer's financial institution requests the data. The requested data is sent to the Customer's financial institution via a secure connection. Upon receipt of the data, the EFTPOS data sent with the merchant receipt data is used to match the merchant's receipt data with the EFTPOS transaction data that has been received by the Customer's financial institution in the known manner, at which time the computer system of the customer's financial institution will make appropriate links and/or entries customer's account.

Optionally, the receipt data sent and stored at the third party location is first encrypted and/or compressed. This encrypted/compressed data is sent to the customer's financial institution. The computer system of the customer's financial institution decrypts and/or decompresses the data prior to making appropriate links and/or entries in the customer's account.

In another preferred embodiment of the present invention, the merchant receipt data is not attached to the EFTPOS transaction data of the customer's financial institution but is sent along with at least some of the EFTPOS data to a third party location via a secure connection as outlined above. However, in this embodiment the receipt data is held at the third party location until such time that the Customer's financial institution requests the data. In accordance with this preferred embodiment of the present invention the Customer's financial institution only requests the data for a specific transaction in response to the customer requesting information by accessing the financial institution's internet banking webpage. The requested data is sent to the Customer's financial institution via a secure connection. Upon receipt of the data, the EFTPOS data sent with the receipt data is used to match the merchant's receipt data with the EFTPOS transaction data that has been received by the Customer's financial institution in the known manner, at which time the computer system of the customer's financial institution will make appropriate links and/or entries in the customer's account.

Optionally, the receipt data sent and stored at the third party location is first encrypted and/or compressed. This encrypted/compressed data is sent to the customer's financial institution. The computer system of the customer's financial institution decrypts and/or decompresses the data prior to making links and/or entries in the customer's account.

In another preferred embodiment of the present invention, the merchant receipt data is not attached to the EFTPOS transaction data of the customer's financial institution but is sent along with at least some of the EFTPOS data to a third party location via a secure connection as outlined above. However, in this embodiment the receipt data is held at the third party location until such time that the Customer's financial institution requests the data. In accordance with this preferred embodiment of the present invention the Customer's financial institution only requests the data for a specific transaction in response to the customer requesting information by accessing the financial institution's internet banking webpage. The requested data is then made available to the computer system of the Customer's financial institution via a secure connection. The computer system of the customer's financial institution then displays the data to the customer via the institution's internet banking webpage. In accordance with this embodiment of the present invention internet banking page of the customer's financial institution will be displaying information not held on the servers of the customer's financial institution but at the third party location.

Optionally, the receipt data sent and stored at the third party location is first encrypted and/or compressed. The computer system of the third party location decrypts and/or decompresses the data prior to transmitting it to the computer system of the customer's financial institution for display on the internet banking page of the customer's financial institution.

The system of the present invention has utility in a large range of situations such as:
Substantiating tax claims;
Validating warranty claims for faulty goods;
Informational purposes about where a product was purchased; and
Enhancing Tax Office compliance activities

The retail payments can take place on a variety of software systems architectures, including scheme networks, the internet, blockchain, and the like. The invention does not depend on any one particular kind of transfer or storage. The transaction listing may be viewed via a consumer's banking app or browser on a smart phone or tablet. The receipt information may also be transferred to a third party location such as a cloud storage.

Modifications and variations as would be apparent to a skilled addressee are deemed to be within the scope of the present invention.

1. A system for the transmission and storage of electronic receipt data relating to electronic funds transfers, characterised in that merchant receipt data and EFTPOS transaction data are transmitted electronically to at least one remote location, such that a re-creation of the original receipt, is made available to the customer in an electronic format.

2. A system according to claim 1, characterised in that data is transmitted to a remote location which is the customer's financial institution.

3. A system according to claim 1, characterised in that data is transmitted to a remote location which is a third party location for storage.

4. A system according to claim 3, characterised in that data transmitted to the third party location comprises merchant receipt data and at least some EFTPOS transaction data.

5. A system according to claim 3, characterised in that data transmitted to the third party location is at least partially encrypted and/or compressed

6. A system according to claim 3, characterised in that data transmitted to the third party location comprising merchant receipt data and at least some EFTPOS transaction data, is further automatically transmitted to the customer's financial institution at a predetermined time.

7. A system according to claim 3, characterised in that data transmitted to the third party location comprising merchant receipt data and at least some EFTPOS transaction data, is further transmitted to the customer's financial institution at the request of the financial institution.

8. A system according to claim 3, characterised in that data transmitted to the third party location comprising merchant receipt data and at least some EFTPOS transaction data, is made available to the customer's financial institution at the request of the financial institution.

9. A system according to claim 7, characterised in that a request from the customer to the financial institution will cause a request to be sent to the third party location for the relevant data.

10. A system according to claim 1, characterised in that the merchant receipt data and the EFTPOS transaction data to be transmitted first undergoes a process of encryption and/or compression prior to transmission.

11. A system according to claim 1, characterised in that the re-creation of the receipt, provided to the customer in electronic format, is the same to that produced by the merchant at the time of the transaction.

12. A system according to claim 1, characterised in that the re-creation of the receipt, provided to the customer in electronic format, is the same to that produced by the merchant at the time of the transaction A method for the transmission and storage of electronic receipt data relating to an electronic funds transfer, the method characterised by:
Attaching the merchant's receipt data to the EFTPOS transaction data;
Transmitting electronically merchant receipt data and EFTPOS transaction data to at least one remote location;
Linking the receipt data and EFTPOS transaction data to the customer's account; and
Making an electronic copy of the merchant's receipt available to the customer.

13. A method according to claim 12, characterised in that a remote location is the customer's financial institution;

14. A method according to claim 12, characterised in that the steps of linking and producing an electronic copy are not completed until such time as a customer or an authorised third party requests a copy of the receipt.

15. A method according to claim 13, characterised in that the method further comprises the step of transmitting the merchant receipt data and at least some of the EFTPOS transaction data to a third party location for storage and, upon receiving a request from the customer's financial institution, establishing a secure connection between the customer's financial institution and the third party location, and subsequently transmitting electronically merchant receipt data and EFTPOS data to the financial institution.

16. A method according to claim 13, characterised in that the method further comprises the step of establishing a secure connection between the customer's financial institution and the third party location in response to a request from the customer.

17. A method according to claim 12, characterised in that the method further comprises the step of encrypting the merchant receipt data and EFTPOS transaction data to be sent to at least one remote location.

18. A method according to claim 17, characterised in that the method further comprises the step of decrypting the merchant receipt data and EFTPOS transaction data received by a third party location.

19. A method according to claim 15, characterised in that the method further comprises the step of making available over a secure connection the data stored at the third party location to the customers financial institution.

20. A method according to claim 13, characterised in that the method further comprises the step of making available over a secure connection data stored at a third party location to the customer's financial institution and further making that data available to the customer's financial institution.
